(19) United States
(12) Patent Application Publication
(10) Pub. No.: US 2006/0195891 A1
(43) Pub. Date: Aug. 31, 2006

(54) Network status indication system

(76) Inventors: Phillip Kent Freyman, Elgin, IL (US); Gordon B. Beacham, San Diego, CA (US); Abhijit Chatterjee, San Diego, CA (US); Christopher J. Cotignola, Doylestown, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/302,444

(22) Filed: Dec. 13, 2005

Related U.S. Application Data
(60) Provisional application No. 60/656,494, filed on Feb. 25, 2005.

(51) Int. Cl. H04L 9/32; G06K 9/00; G06F 17/30; G06F 15/16; G06F 7/04; G06F 7/58; G06K 19/00

(52) U.S. Cl. 726/4

(57) ABSTRACT

A system for signaling a distributed network status indication to a local user includes an access device configured to monitor a status of the distributed network and a processing module configured to process information pertaining to the monitored status of the distributed network. The system also includes at least one user device comprising a status identifier, where the processing module is configured to transmit a signal to the at least one user device pertaining to the monitored status of the distributed network, and where the status identifier of the at least one user device is configured to output an indication corresponding to the status of the distributed network.

### PRIORITY

The present application claims benefit of U.S. Provisional Patent Application Ser. No. 60/656,494, filed on Feb. 25, 2005, the disclosure of which is hereby incorporated by reference in its entirety.

### FIELD

The present invention generally relates to networks, and more particularly to notification of network status to a user device.

### BACKGROUND

Historically, an end user could detect the loss of telephony service by attempting to initiate a phone connection and by not receiving a dial tone. In addition, home devices, such as, security systems, could detect the loss of direct current bias on the telephone line and could therefore assume that the loss of power was due to a connection failure. The detection of this network state or status was then interpreted as a signal to initiate local user or device action (hang up the phone or security system alarming). In either case, the user or the home security system could relatively easily detect the failure in the telephone line based on the state of direct current bias or lack of dial tone on the line.

Internet-based applications have rapidly expanded due, in large part, to the expansive availability and relatively low costs associated with the use of the Internet-based applications. One of these applications involves the transmission of voice communications over the Internet, or voice-over-internet-protocol (VoIP) applications. VoIP applications typically replace existing telephony service, such that traditional telephone lines and services are no longer required to enable voice communications.

Users and security systems that utilize VoIP and other Internet-based applications, are unable, however, to relatively easily detect possible connection problems with an Internet connection, which potentially poses a threat to the user's safety and health because the line state indicated by the direct current bias is locally generated in the access device and is not network generated. It can thus be appreciated that a need exists for access devices to intentionally signal users and security systems when connections to the Internet have been disrupted or have failed, in a relatively easy manner.

### SUMMARY

A system for signaling a distributed network status indication to a local user is disclosed herein. The system includes an access device configured to monitor a status of the distributed network and a processing module configured to process information pertaining to the monitored status of the distributed network. The system also includes at least one user device comprising a status identifier, where the processing module is configured to transmit a signal to the at least one user device pertaining to the monitored status of the distributed network, and where the status identifier of the at least one user device is configured to output an indication corresponding to the status of the distributed network.

### BRIEF DESCRIPTION OF THE DRAWINGS

Features of the present invention will become apparent to those skilled in the art from the following description with reference to the figures, in which:

FIG. 1 shows a block diagram of a system for providing a distributed network status indication, according to an embodiment of the invention;

FIGS. 2 and 3, respectively, illustrate flow diagrams of methods for providing distributed network status indication information, according to embodiments of the invention; and

FIG. 4 illustrates a computer system, which may be employed to perform various functions described herein, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

A system and method for providing an indication of the distributed network status is described herein. The distributed network may be defined as the access network onto, and including, the Internet provided by a network service provider 140, such as a cable or DSL broadband service provider. As described in greater detail herein below, the distributed network status may be monitored by an access device. The access device may additionally process information pertaining to the monitored status as well as transmit signals to at least one user device configured to output an indication of the distributed network status. In one regard, therefore, the access device and the at least one user device disclosed herein may be employed to provide an indication of the distributed network status in a relatively simple and inexpensive manner.

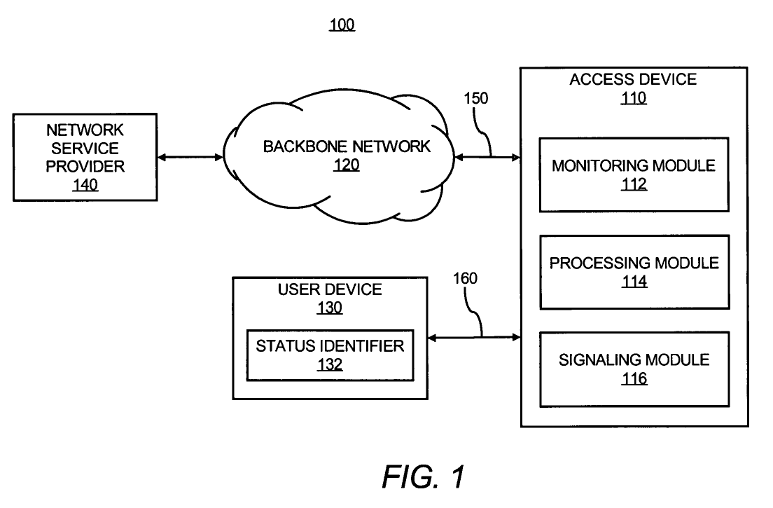

With reference first to FIG. 1, there is shown a block diagram of a system 100 for signaling a distributed network status indication to a local user. It should be readily apparent that the system 100 depicted in FIG. 1 represents a generalized illustration and that other components may be added or existing components may be removed or modified without departing from a scope of the system 100. For example, the system 100 may include any reasonably suitable number of access devices and user devices.

As shown in FIG. 1, the system 100 includes an access device 110 in communication with a distributed network 120 and a user device 130. The access device 110 generally comprises an apparatus configured to provide one or both of telephony access and broadband access to the user device 130. In this regard, the access device 110 may comprise, for instance, a cable modem, a digital subscriber line (DSL) modem, a network router, a network bridge, a media terminal adaptor (MTA), and the like.

Generally speaking, the MTA is an interface used to deliver broadband Internet, data, and/or voice access jointly with telephony service to a user's premises using a cable network infrastructure. The MTA is typically installed at the customer or subscriber's premises, and is coupled to a multiple system operator (MSO) using a hybrid fiber coax (HFC), a wireless radio wave access network, an optical access network, or the like. In one example, the MTA may be employed in a voice-over-internet protocol (VoIP) embedded-media-terminal-adaptor (EMTA) or a VoIP standalone-media-terminal-adaptor (SMTA).

The access device 110 is also depicted as including a monitoring module 112, a processing module 114, and a signaling module 116. One or more of the modules 112-116 may comprise software stored either locally or in an external memory. In addition, or alternatively, one or more of the modules 112-116 may comprise one or more hardware devices. In any regard, the modules 112-116 may be configured to perform various functions as described in detail herein below.

The monitoring module 112 may be configured to monitor, for instance, a status of the distributed network 120 through a connection with the distributed network 120, as indicated by the arrow 150. The monitoring module 112 may monitor the status of the distributed network 120 through any reasonably suitable known manner, for instance but not limited to, a session initiation protocol (SIP) register method, an icmp ping, a heartbeat message, a dns resolution, etc. In addition, the access device 110 may be connected to the distributed network 120 through, for instance, a hybrid fiber coax (HFC).

Information pertaining to the monitored status of the distributed network 120 may be processed by the processing module 114. In one example, the processing module 114 may determine whether the connection between the access device 110 and the distributed network 120 is active or whether there has been a failure in the connection with the distributed network 120 itself. A failure may be detected, for example, if there is a loss of connectivity between the access device 110 and the distributed network 120, which may be caused by either or both of a hardware and a software problem. As another example, a failure may be caused by a problem with the network service provider 140, such as, a power failure, hardware or software problems, and the like. The processing module 114 may also determine that a failure has occurred if, for instance, the connection bandwidth between the access device and the distributed network 120 falls below a predetermined value.

In any regard, the signaling module 116 may transmit the processed information to the user device 130 through a connection with the user device 130, as generally indicated by the arrow 160. The signal may include information processed regarding the general status of the distributed network 120 and more particularly, to a failure status of the distributed network 120. In a first example, the connection between the access device 110 and the user device 130 may comprise a telephone line. In this example, the user device 130 may comprise, for instance, a telephone, a video telephone, an answering machine, a television, a security system, etc.

In a second example, the connection between the access device 110 and the user device 130 may comprise at least one of a wired and a wireless Ethernet connection. More particularly, for instance, the connection may be performed according to a wired protocol, such as EEEE 802.3, etc., or wireless protocols, such as IEEE 802.11a, 802.11b, 802.11g, wireless serial connection, Bluetooth, etc., or combinations thereof. In this example, the user device 130 may comprise a device operable to connect to a network, for instance, a computer, a personal digital assistant, a printer, a network-enabled telephone, a television, a security system, etc. In addition, the user device 130 may be connected to the access device 110 through a secondary access device (not shown). The secondary access device in this example may comprise at least one of a router and an Ethernet bridge configured to facilitate data transfer between the access device 110 and the user device 130. The secondary access device may be employed, for instance, in a VoIP system where the user device 140 comprises at least one of a conventional telephone and answering machine and the secondary access device (such as, an Ethernet bridge, router, VoIP modem, etc.) operates to enable communications between the at least one of the conventional telephone and answering machine and the access device 110.

According to a third example, the user device 130 may comprise an apparatus specifically designed to output an indication pertaining to the detected status of the distributed network 120. In one regard, the user device 130 according to this example other functions of the user device 130 may be secondary to the status indication output function.

In any of the examples above, the user device 130 may be configured to output a status indication of the distributed network 120 through operation of a status identifier 132. Broadly speaking, the status identifier 132 may comprise any reasonably suitable apparatus configured to output an indication of the distributed network 120 status. In addition, the status identifier 132 may comprise any of a number of various status indicating devices and may be selected according to the user device 140 used in the system 100.

The status identifier 132 may comprise at an audible signaling device, such as, a speaker, a bell, a tone producing device, etc., a visual signaling device, such as, a light emitting diode (LED), a display screen, etc., and combinations thereof, such as, a video phone and the like. Examples of various suitable user devices 130 and status identifiers 132 are provided below for purposes of illustration and not of limitation. It should be clearly understood that the following examples are not exhaustive and that many other combinations of user devices 130 and status identifiers 132 may be employed in the system 100 without departing from a scope of the system 100.

In a first example, the user device 130 may comprise a telephone and the status identifier 132 may comprise an audible signaling device. In this example, the status identifier 132 may comprise one or both of a tone and a voice announcement, where the tone announcement may include a silent announcement, similar to a disconnection of the local telephony connection. As such, for instance, the status identifier 132 may be configured to output at least one of a tone and a voice announcement to indicate the status of the connectivity between the access device 110 and the distributed network 120. Thus, for example, the status identifier 132 may comprise a specialized dial tone, ring tone, voice announcement, etc., designed to indicate whether the distributed network 120 connection is active or has failed.

In another example, the status identifier 132 may also comprise one or both of a tone and a voice announcement and the user device 130 may comprise an apparatus networked with the access device 110 through either or both of a wired and an wireless Ethernet connection. The user device 130 in this example may comprise, for instance, a computer, a personal digital assistant, a printer, a television, a security system, etc., configured with the status identifier 132, such that, the user device 130 may output an audible indication of the connectivity status. Also in this example, the status identifier 132 may comprise a specialized tone, ring, voice announcement, etc., designed to indicate whether the distributed network 120 connection is active or has failed. In addition, the voice announcement may be customizable by the user, for instance, through selection of the language, the text of the announcement, etc.

In a further example, the status identifier 132 may comprise a visual signaling device configured to provide a visual indication of the connectivity status. For instance, the status identifier 132 may comprise an LED configured to emit light when the distributed network 120 has been detected to have failed. In addition, or alternatively, a first LED configured to emit a first color light may be activated when the distributed network 120 is detected to be active and a second LED configured to emit a second color light may be activated when the distributed network 120 is detected to have failed.

The status identifier 132 may also comprise a display configured to visually provide connectivity status information. The connectivity status information according to this example may comprise text or an image indicating the connectivity status. The display may comprise, for instance, a liquid crystal display of a telephone, a security system, a television, a computer monitor, etc.

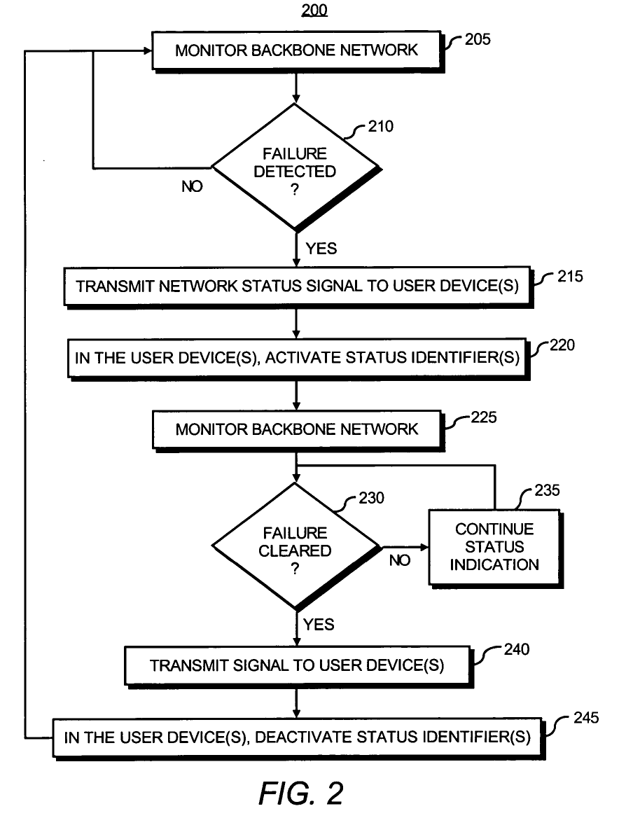

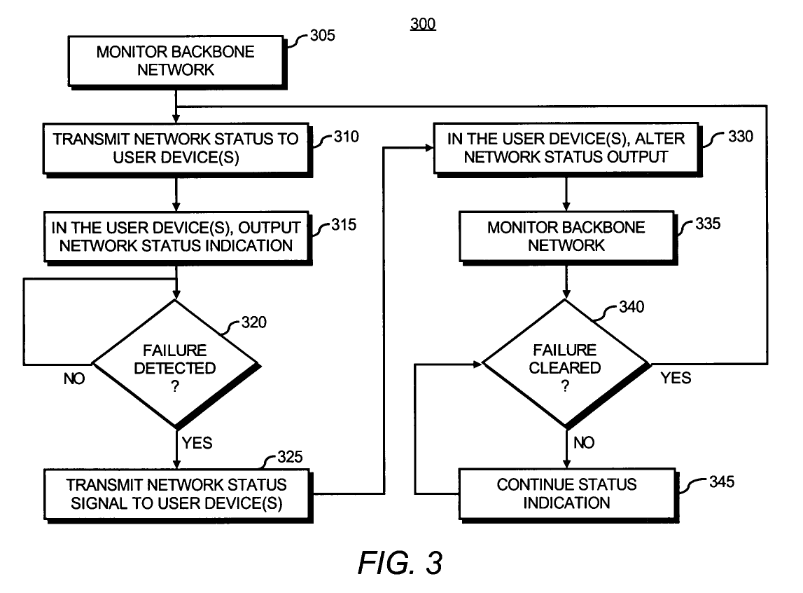

FIGS. 2 and 3, respectively show flow diagrams of methods 200 and 300 for providing distributed network status indication information, according to a two examples. It is to be understood that the following description of the methods 200 and 300 are but two manners of a variety of different manners in which examples of the system 100 may be practiced. It should also be apparent to those of ordinary skill in the art that the methods 200 and 300 represent generalized illustrations and that other steps may be added or existing steps may be removed, modified or rearranged without departing from the scopes of the methods 200 and 300.

The descriptions of the methods 200 and 300 are made with reference to the system 100 illustrated in FIG. 1, and thus makes reference to the elements cited therein. It should, however, be understood that the methods 200 and 300 are not limited to the elements set forth in FIG. 1. Instead, it should be understood that the methods 200 and 300 may be practiced by systems having different configurations than the system 100 depicted in FIG. 1.

Generally speaking, the methods 200 and 300 may be performed to provide a user with an indication of the status of a distributed network 120. In the method 200, the distributed network 120 status indication is outputted in the event that a failure in the distributed network 120 is detected. In addition, in the method 300, the distributed network 120 indication is substantially continuously outputted, with the output being changed in response to a failure in the distributed network 120 being detected.

With particular reference now to FIG. 2, the monitoring module 112 may monitor the distributed network 120 at step 205. More particularly, for instance, the monitoring module 112 may monitor a connection status between the access device 110 and the distributed network 120 through any reasonably suitable known manner. In addition, the processing module 114 may process the information regarding the connection status between the access device 110 and the distributed network 120. In processing the connection status, the processing module 114 may, for instance, determine whether the connection between the access device 110 and the distributed network 120 is active or whether the connection has failed, as indicated at step 210.

If the processing module 114 determines that the connection between the access device 110 and the distributed network 120 is active, the monitoring module 112 may continue to monitor the distributed network 120 as indicated at step 205. If, however, the processing module 114 determines that a failure, such as a loss in the connectivity between the access device 110 and the distributed network 120, has occurred, the signaling module 116 may transmit a signal regarding the network status to one or more user devices 130, as indicated at step 215. In addition, at step 220, the user devices(s) 130 may activate their respective status identifier(s) 132 to output an indication that a failure in the connection with the distributed network 120 has occurred in response to receipt of the network status signal from the signaling module 116.

Following activation of the status identifier(s) 132, the monitoring module 112 may continue to monitor the distributed network 120, as indicated at step 225. In addition, the processing module 114 may process the monitored status information obtained by the monitoring module 112 to determine whether connectivity between the access device 110 and the distributed network 120 has been restored, as indicated at step 230. If the processing module 114 determines that the connectivity has not been restored, the status identifier(s) 132 may continue to output the failure indication, as indicated at step 235. In other words, the status identifier(s) 132 may continue in the activated mode absent receipt of another network status signal from the access device 110.

In addition, steps 230 and 235 may be repeated in a substantially continuous manner until the processing module 114 determines that the connectivity has been restored at step 230. When the processing module 114 determines that the connectivity has been restored, the signaling module 116 may transmit a signal to the user device(s) 130 to deactivate the status identifier(s) 132, as indicated at step 240. In response to receipt of the signal from the signaling module 116, the user devices(s) 130 may deactivate their respective status identifier(s) 132, as indicated at step 245.

The method 200 may be performed in a substantially continuous manner to thereby substantially continuously monitor the status of the distributed network 120 and to notify a user of the monitored status. More particularly, the method 200 may be performed in a substantially continuous manner to inform users of possible distributed network 120 failures as the failures occur.

Turning now to FIG. 3, the monitoring module 112 may monitor the distributed network 120 at step 305 in manners similar to those discussed above with respect to step 205 in FIG. 2. In addition, the processing module 114 may process the information regarding the connection status between the access device 110 and the distributed network 120. However, in contrast to the method 200, the signaling module 116 may transmit a signal pertaining to the status of the distributed network 120 to one or more user devices 130, as indicated at step 310. In this respect, the signaling module 116 may transmit the status information regardless of whether the connectivity between the access device 110 and the distributed network 120 is active or has failed.

As indicated at step 315, in response to receipt of the signal from the signaling module 116, the user device(s) 130 may implement the respective status identifier(s) 132 to output an indication corresponding to the signal received from the signaling module 116. More particularly, for instance, the status identifiers(s) 132 may output an indication that the connectivity between the user device(s) 130 and the distributed network 120 is active at step 315.

During performance of steps 310 and 315, the monitoring module 112 may continue to monitor the connectivity between the access device 110 and the distributed network 120. The processing module 114 may also continue to process information pertaining to the connectivity and to determine whether the connectivity has failed, as indicated at step 320. If the processing module 114 determines that the connection between the access device 110 and the distributed network 120 is active, the monitoring module 112 may continue to monitor the distributed network 120 and the processing module 114 may continue to process the status information at step 320.

If, however, the processing module 114 determines that a failure, such as a loss in the connectivity between the access device 110 and the distributed network 120, has occurred, the signaling module 116 may transmit a signal regarding the network status to the user device(s) 130, as indicated at step 325. In addition, at step 330, the user devices(s) 130 may alter their respective status identifier(s) 132 to output an indication that a failure in the connection with the distributed network 120 has occurred in response to receipt of the network status signal from the signaling module 116.

Following alteration of the status identifier(s) 132, the monitoring module 112 may continue to monitor the distributed network 120, as indicated at step 335. In addition, the processing module 114 may process the monitored status information obtained by the monitoring module 112 to determine whether the connectivity between the access device 110 and the distributed network 120 has been restored at step 340. If the processing module 114 determines that the connectivity has not been restored, the status identifier(s) 132 may continue to output the failure indication at step 345.

In addition, steps 340 and 345 may be repeated in a substantially continuous manner until the processing module 114 determines that the connectivity has been restored at step 340. When the processing module 114 determines that the connectivity has been restored, the signaling module 116 may transmit a signal to the user device(s) 130 indicating that the connectivity is active as indicated at step 310. In addition, the user devices(s) 130 may alter their respective status identifier(s) 132 to output an indication that the connection between the access device(s) 130 and the distributed network 120 is active in response to receipt of the network status signal from the signaling module 116, as indicated at step 315.

Moreover, steps 310-345 may be performed in a substantially continuous manner to thereby substantially continuously monitor the status of the distributed network 120 and to notify a user of the monitored status.

Some or all of the operations set forth in the methods 200 and 300 may be contained as a utility, program, or subprogram, in any desired computer accessible medium. In addition, some or all of the methods 200 and 300 may be embodied by a computer program, which can exist in a variety of forms both active and inactive. For example, it can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

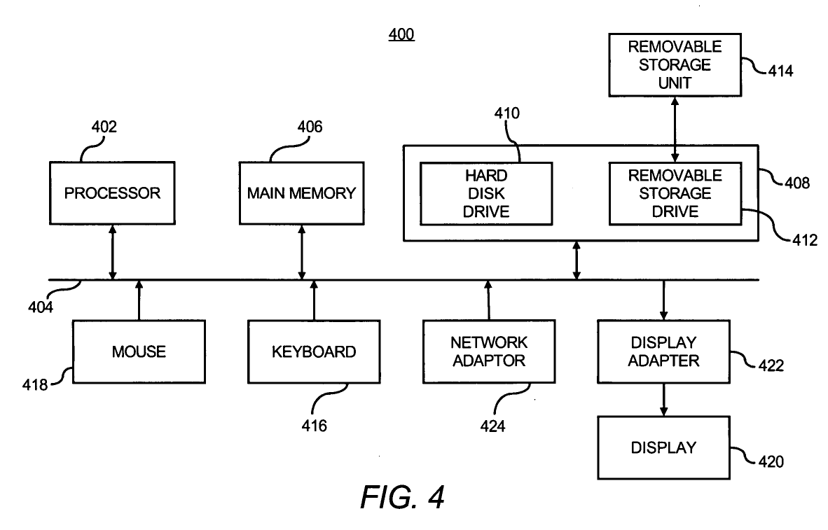

FIG. 4 illustrates a computer system 400, which may be employed to perform the various functions of the access device 110 described hereinabove, according to an embodiment. In this respect, the computer system 400 may be used as a platform for executing one or more of the functions described hereinabove with respect to the access device 110.

The computer system 400 includes a processor 402 configured to execute some of the steps described in the methods 200 and 300. More particularly, for instance, the processor 402 may be configured to execute the modules 112-116. Commands and data from the processor 402 are communicated over a communication bus 404. The computer system 400 also includes a main memory 406, such as a random access memory (RAM), where the program code for, for instance, access device 110, may be executed during runtime. The computer system 400 may also include a secondary memory 408, for example, one or more hard disk drives 410 and/or a removable storage drive 412, representing a floppy diskette drive, a magnetic tape drive, a compact disk drive, etc., where a copy of the program code for the access device 110 may be stored.

The removable storage drive 410 reads from and/or writes to a removable storage unit 414 in a well-known manner. The computer system 400 may also include user input and output devices, which may include a keyboard 416, a mouse 418, and a display 420. A display adaptor 422 may interface with the communication bus 404 and the display 420 and may receive display data from the processor 402 and convert the display data into display commands for the display 420. In addition, the processor 402 may communicate over a network, for instance, the Internet, LAN, etc., through a network adaptor 424.

It will be apparent to one of ordinary skill in the art that other known electronic components may be added or substituted in the computer system 400. In addition, the computer system 400 may include a system board or blade used in a rack in a data center, a conventional “white box” server or computing device, etc. Also, one or more of the components in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A system for signaling a distributed network status indication to a local user, said system comprising:
an access device configured to monitor a status of the distributed network;
a processing module configured to process information pertaining to the monitored status of the distributed network; and
at least one user device comprising a status identifier, wherein the processing module is configured to transmit a signal to the at least one user device pertaining to the monitored status of the distributed network, and wherein the status identifier of the at least one user device is configured to output an indication corresponding to the status of the distributed network.

2. The system according to claim 1, wherein the distributed network comprises a network service provided by a network service provider.

3. The system according to claim 1, wherein the processing module forms part of the access device.

4. The system according to claim 1, wherein the signal transmitted from the processing module to the at least one user device comprises a wireless signal.

5. The system according to claim 1, wherein the processing module is configured to determine whether a failure in the distributed network has occurred, and wherein the status identifier of the at least one user device is configured to output an indication that a failure in the distributed network has occurred in response to receipt of the signal from the processing module.

6. The system according to claim 1, wherein the access device comprises at least one of a cable modem, a digital subscriber line modem, a media terminal adaptor, a network router, and a network bridge.

7. The system according to claim 1, wherein the at least one user device comprises a at least one of a telephone, a video telephone, an answering machine, a security system and a television set, and wherein the at least one user device is connected to the access device through a telephone line.

8. The system according to claim 1, wherein the at least one user device comprises an apparatus networked with the access device through at least one of a wired and a wireless Ethernet connection.

9. The system according to claim 8, wherein the at least one user device comprises at least one of a computer, a portable digital assistant, a security system, a television, and a printer.

10. The system according to claim 1, wherein the indication corresponding to the status of the distributed network output by the status identifier comprises at least one of an audible and a visual output.

11. An access device comprising:
a monitoring module for monitoring a distributed network;
a processing module for processing information pertaining to the monitored distributed network; and
a signaling module for signaling at least one user device of the processed information, wherein the at least one user device is configured to output an indication of the distributed network status.

12. The access device according to claim 11, wherein the processing module is configured to detect a failure in the distributed network, and wherein the module for signaling is configured to transmit a signal to the at least one user device of the detected failure, and wherein the at least one user device is configured to activate a status identifier to output an indication that a failure in the distributed network has occurred.

13. The access device according to claim 11, wherein the access device comprises at least one of a cable modem, a digital subscriber line modem, a network router, a network bridge, and a media terminal adaptor.

14. A method for providing distributed network status indication information, said method comprising:
monitoring the distributed network status with an access device;
transmitting a signal to at least one user device pertaining to the status of the distributed network; and
in the at least one user device, employing a status identifier to indicate the status of the distributed network.

15. The method according to claim 14, further comprising:
determining whether a failure in the distributed network has occurred; and
wherein transmitting a signal comprises transmitting a signal to the at least one user device pertaining to the failure in the distributed network occurring, and wherein employing a status identifier comprises employing the status identifier to indicate that a failure in the distributed network has occurred.

16. The method according to claim 15, further comprising:
determining whether the failure in the distributed network has cleared; and
continuing to employ the status identifier to indicate that a failure in the distributed network has occurred in response to a determination that the failure has not cleared.

17. The method according to claim 15, further comprising:
determining whether the failure in the distributed network has cleared; and
discontinuing the employment of the status identifier to indicate that a failure in the distributed network has occurred in response to a determination that the failure has cleared.

18. The method according to claim 14, further comprising:
determining whether a failure in the distributed network has occurred; and
transmitting a second signal to the at least one user device pertaining to the failure in the distributed network occurring, and wherein employing a status identifier comprises altering operation of the status identifier to indicate that a failure in the distributed network has occurred.

19. The method according to claim 14, wherein transmitting a signal further comprises transmitting a signal over a telephone line to the at least one user device.

20. A system for providing distributed network status indication information on a user device, said system comprising:
means for monitoring the distributed network status;
means for processing information pertaining to the monitored distributed network status;
means for transmitting a signal corresponding to the processed information; and
means for indicating the status of the distributed network on the user device, wherein the means for indicating is configured to operate based upon the signal transmitted from the means for transmitting.

21. A computer program product embodied on a computer-readable medium and comprising code that, when executed, causes a computer to perform the following:
monitor a distributed network status;
process information pertaining to the monitored distributed network status; and
transmit a signal pertaining to the processed information to at least one user device, wherein the at least one user device includes a status identifier to indicate the distributed network status through output of at least one of a visible and audible indication.
